(19) United States
(12) Patent Application Publication
(10) Pub. No.: US 2025/0220671 A1
(43) Pub. Date: Jul. 3, 2025

(54) UPLINK CHANNEL SENDING AND RECEIVING METHOD AND APPARATUS

(71) Applicant: Beijing Xiaomi Mobile Software Co., Ltd., Beijing (CN)

(72) Inventor: Xueyuan GAO, Beijing (CN)

(21) Appl. No.: 18/852,294

(22) PCT Filed: Mar. 31, 2022
(86) PCT No.: PCT/CN2022/084482

§ 371 Date: Sep. 27, 2024

(51) Int. Cl. H04W 72/21; H04B 7/06

(52) U.S. Cl. CPC H04W 72/21; H04B 7/0626; H04B 7/0639

(57) ABSTRACT

A transmitting method for an uplink channel, executed by a terminal device, includes: receiving indication information related to precoding transmitted by a network device, determining a precoding codeword corresponding to each sub-band of the uplink channel according to the indication information, precoding each corresponding sub-band of the uplink channel with the precoding codeword corresponding to each sub-band, and transmitting the uplink channel, of which each sub-band has been precoded, to the network device.

### CROSS-REFERENCE TO RELATED APPLICATIONS

The present application is a U.S. National Stage of International Application No. PCT/CN2022/084482, filed on Mar. 31, 2022, the contents of all of which are incorporated herein by reference in their entirety for all purposes.

### BACKGROUND OF THE INVENTION

In a 5th generation mobile communication technology (5G) new radio (NR) system, an uplink transport method based on a codebook is commonly used to determine spatial multiplexing of uplink channel precoding on the basis of a fixed codebook.

### SUMMARY OF THE INVENTION

An example of a first aspect of the disclosure provides a transmitting method for an uplink channel. The method is executed by a terminal device and includes:
receiving indication information related to precoding transmitted by a network device;
determining a precoding codeword corresponding to each sub-band of the uplink channel according to the indication information;
precoding each corresponding sub-band of the uplink channel with the precoding codeword corresponding to each sub-band; and
transmitting the uplink channel, of which each sub-band has been precoded, to the network device.

An example of a second aspect of the disclosure provides a receiving method for an uplink channel. The method is executed by a network device and includes:
transmitting indication information related to precoding to a terminal device, where the indication information is configured to determine a codeword corresponding to each sub-band of the uplink channel; and
receiving the uplink channel, of which each sub-band has been precoded, transmitted by the terminal device.

An example of another aspect of the disclosure provides a communication apparatus. The apparatus includes a processor and a memory. A computer program is stored in the memory. The processor executes the computer program stored in the memory to cause the apparatus to execute the transmitting method for an uplink channel mentioned in the example of the first aspect.

An example of another aspect of the disclosure provides a communication apparatus. The apparatus includes a processor and a memory. A computer program is stored in the memory. The processor executes the computer program stored in the memory to cause the apparatus to execute the receiving method for an uplink channel mentioned in the example of the second aspect.

An example of another aspect of the disclosure provides a non-transitory computer-readable storage medium. The computer-readable storage medium is configured to store an instruction. The instruction causes the transmitting method for an uplink channel mentioned in the example of the first aspect to be implemented when executed.

An example of another aspect of the disclosure provides a non-transitory computer-readable storage medium. The computer-readable storage medium is configured to store an instruction. The instruction causes the receiving method for an uplink channel mentioned in the example of the second aspect to be implemented when executed.

### BRIEF DESCRIPTION OF DRAWINGS

The above and/or additional aspects and advantages of the disclosure will become apparent and easy to understand from descriptions of examples in combination with accompanying drawings.

FIG. 1 is a schematic diagram of an architecture of a communication system according to an example of the disclosure;

FIG. 2 is a schematic flow diagram of a transmitting method for an uplink channel according to an example of the disclosure;

FIG. 3 is a schematic flow diagram of another transmitting method for an uplink channel according to an example of the disclosure;

FIG. 4 is a schematic flow diagram of yet another transmitting method for an uplink channel according to an example of the disclosure;

FIG. 5 is a schematic flow diagram of yet another transmitting method for an uplink channel according to an example of the disclosure;

FIG. 6 is a schematic flow diagram of still another transmitting method for an uplink channel according to an example of the disclosure;

FIG. 7 is a schematic diagram of a beam forming pattern according to an example of the disclosure;

FIG. 8 is a schematic flow diagram of a receiving method for an uplink channel according to an example of the disclosure;

FIG. 9 is a schematic structural diagram of a transmitting apparatus for an uplink channel according to the disclosure;

FIG. 10 is a schematic structural diagram of a receiving apparatus for an uplink channel according to the disclosure;

FIG. 11 is a schematic structural diagram of a transmitting apparatus for an uplink channel according to the disclosure; and

FIG. 12 is a schematic structural diagram of a chip according to an example of the disclosure.

### DETAILED DESCRIPTION OF THE INVENTION

Examples of the disclosure will be described in detail below, and instances of the examples are shown in the accompanying drawings. When the following descriptions involve accompanying drawings, unless otherwise specified, the same numeral in different accompanying drawings denotes the same or similar elements. The embodiments described in the following examples do not denote all embodiments consistent with examples of the disclosure. On the contrary, the embodiments are merely instances of an apparatus and a method consistent with some aspects of the examples of the disclosure as detailed in the appended claims.

The terms used in examples of the disclosure are merely used to describe the particular examples, and are not intended to limit examples of the disclosure. Singular forms such as “a”, “an” and “the” used in examples of the disclosure and the appended claims are also intended to include plural forms, unless otherwise clearly stated in the context. It should also be understood that the term “and/or” used here refers to and includes any or all possible combinations of one or more of associated listed items.

It should be understood that although the terms “first”, “second”, “third”, etc. may be used in examples of the disclosure to describe various types of information, such information should not be limited to these terms. These terms are merely used to distinguish the same type of information from each other. For instance, first information can also be referred to as second information, and similarly, second information can also be referred to as first information, without departing from the scope of examples of the disclosure. Depending on the context, the word “if” as used here may be interpreted as “in a case of”, “in a case that” or “in response to determining”.

The disclosure relates to the technical field of communication, and particularly relates to a transmitting and receiving method and apparatus for an uplink channel.

A present protocol supports uplink transport of only 4 layers at most but downlink transport of 8 layers at most. In order to further improve a transport rate, a research goal of R18 includes increasing to 8 uplink transmitting antennas at most to support an uplink transport rate comparable to a downlink transport rate. How to achieve frequency selective precoding becomes a problem to be solved.

Examples of the disclosure will be described in detail below. Instances of the examples are shown in accompanying drawings, throughout which identical or similar reference numerals denote identical or similar elements. Examples described below with reference to accompanying drawings are illustrative and intended to explain the disclosure, but cannot be construed as a limitation on the disclosure.

In order to better understand a transmitting method for an uplink channel disclosed in an example of the disclosure, a communication system to which an example of the disclosure is applicable is first described below.

With reference to FIG. 1, a schematic diagram of an architecture of a communication system according to an example of the disclosure is shown in FIG. 1. The communication system may include but is not limited to one network device and one terminal device. A number and form of devices shown in FIG. 1 are merely used as instances and do not constitute a limitation on an example of the disclosure. During actual application, two or more network devices and two or more terminal devices may be included. The communication system shown in FIG. 1 includes one network device 101 and one terminal device 102.

It should be noted that the technical solution of an example of the disclosure can be applied to various communication systems, such as: a long term evolution (LTE) system, a fifth generation mobile communication system, a 5th generation mobile communication technology, 5G new radio system or other future new mobile communication systems.

The network device 101 in an example of the disclosure is an entity, which is configured to transmit or receive signals, on a network side. For instance, the network device 101 may be an evolved node B (eNB), a transmission reception point (TRP), a next generation nodeB (gNB) in a new radio (NR) system, a base station in other future mobile communication systems, or an access node in a wireless fidelity (WiFi) system. Specific technologies and specific device forms used for the network device are not limited in examples of the disclosure. The network device provided in an example of the disclosure may be composed of a central unit (CU) and a distributed unit (DU). The CU may also be referred to as a control unit. With a CU-DU structure, protocol layers of the network device such as a base station can be split. Functions of some protocol layers are controlled by the CU in a centralized manner. Functions of some or all of the remaining protocol layers are distributed in the DU. The DU is controlled by the CU in a centralized manner.

The terminal device 102 in an example of the disclosure is an entity such as a mobile phone, which is configured to receive or transmit signals, on a user side. The terminal device may also be referred to as a terminal, user equipment (UE), a mobile station (MS), a mobile terminal (MT), etc. The terminal device may be an automobile having a communication function, a smart automobile, a mobile phone, a wearable device, a tablet (Pad), a computer having a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, etc. Specific technologies and specific device forms used for the terminal device are not limited in examples of the disclosure.

In a 5th generation mobile communication technology (5G) new radio (NR) system, an uplink transport method based on a codebook is commonly used to determine spatial multiplexing of uplink channel precoding on the basis of a fixed codebook.

A present protocol supports uplink transport of only 4 layers at most but downlink transport of 8 layers at most.

In the related art, wideband or sub-band reporting is supported in a frequency domain, and each channel state information (CSI) reporting wideband corresponds to a group of sub-band CSI parameters. In a case that a configuration is wideband precoding matrix indicator (PMI)+wideband channel quality indicator (CQI), and reference signal received power (RSRP) or wideband CQI reporting with no PMI, wideband CSI reporting is carried out. In cases of other configurations, sub-band CSI reporting is carried out. A sub-band size of the sub-band CSI reporting is related to a configured wideband, as shown in Table 1 below. Considering support for different numerology and consistency with a precoding resource block group (PRG) size, 2 candidate sub-band sizes are included in a case of each configuration wideband, and each include a group of continuous physical resource blocks (PRBs) selected by a radio resource control (RRC). During sub-band CSI reporting, a plurality of sub-bands may be configured continuously or discontinuously in the frequency domain.

TABLE 1
CSI sub-band size

| Carrier Bandwidth Part (PRBs) | Sub-band size (PRBs) |
|---|---|
| <24 | N/A |
| 24-72 | 4, 8 |
| 73-144 | 8, 16 |
| 145-275 | 16, 32 |

In order to further improve a transport rate, a research goal of R18 includes increasing to 8 uplink transmitting antennas at most to support an uplink transport rate comparable to a downlink transport rate. How to achieve frequency selective precoding becomes a problem to be solved.

In an example of the disclosure, the indication information-related to precoding transmitted by the network device is received. The precoding codeword corresponding to each sub-band of the uplink channel is determined according to the indication information. Each corresponding sub-band of the uplink channel is precoded with the precoding codeword corresponding to each sub-band. The uplink channel, of which each sub-band has been precoded, is transmitted to the network device. The disclosure is configured to support uplink transport of 8 layers at most. Each corresponding sub-band of the uplink channel of the terminal device is precoded with the corresponding precoding codeword, and frequency selective precoding of uplink transmission of the terminal device is achieved such that the disclosure can better adapt to transmission of a frequency selective channel. Reliability of communication and transport is improved, and overall system performance and efficiency are effectively improved.

It can be understood that the communication system described in an example of the disclosure are used to more clearly explain the technical solution of the example of the disclosure, and do not constitute a limitation on the technical solution provided in the example of the disclosure. Those of ordinary skill in the art can recognize that as system architectures evolve and new service scenarios appear, the technical solution provided in the example of the disclosure is also applicable to similar technical problems.

The transmitting method and apparatus for an uplink channel provided in the disclosure will be introduced in detail below in combination with accompanying drawings.

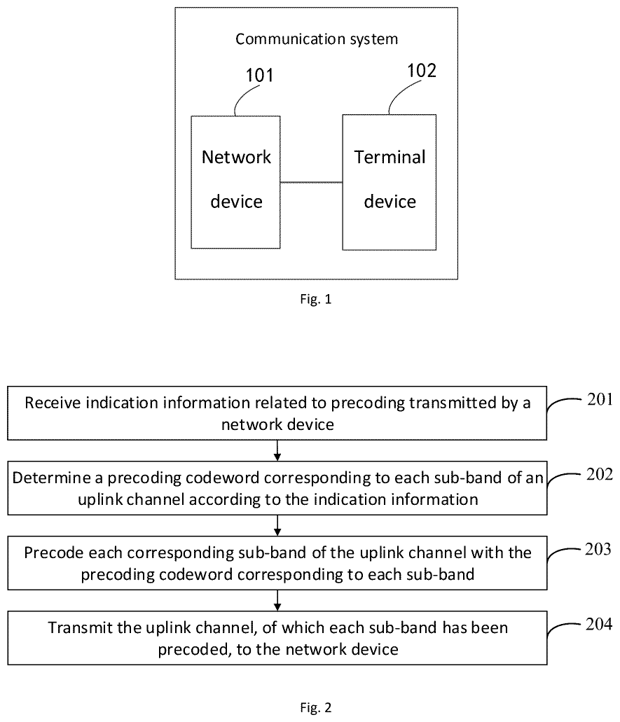

FIG. 2 is a schematic flow diagram of a transmitting method for an uplink channel according to an example of the disclosure. It should be noted that the method in the example of the disclosure is executed by a terminal device. As shown in FIG. 2, the transmitting method for an uplink channel includes steps as follows:

Step 201: indication information related to precoding transmitted by a network device is received.

In an example of the disclosure, the indication information related to precoding transmitted by the network device may be received by the terminal device. Further, a precoding codeword corresponding to each sub-band of the uplink channel may be determined according to the indication information.

In an example of the disclosure, optionally, the uplink channel may be a physical uplink shared channel (PUSCH).

Optionally, the indication information is configured to indicate at least one of:
at least one transmission precoding matrix indicator (TPMI); a first wideband precoding matrix indicator (PMI) information; a number L of beams included in a first wideband beam group, where L is a positive integer; a beam forming pattern corresponding to the first wideband beam group; channel state information (CSI) including PMI information of at least one sub-band; and part of channel state information (CSI).

Step 202: a precoding codeword corresponding to each sub-band of an uplink channel is determined according to the indication information.

In some embodiments, the indication information is configured to indicate the first wideband PMI information and the channel state information (CSI) including precoding information of at least one sub-band. The precoding codeword corresponding to each sub-band of the uplink channel of the terminal device may be directly determined by the terminal device according to the channel state information (CSI) indication including precoding information of at least one sub-band and the first wideband PMI information. Optionally, the indication information may be carried in downlink control information (DCI).

In some embodiments, the indication information is configured to indicate part of channel state information (CSI). As an instance, the part of the CSI is a transmission rank indicator (TRI). Precoding information of a wideband and a sub-band may be determined by the terminal device according to the part of the CSI and by combining a precoding matrix estimated by the terminal device with part of the CSI fed back by the network device. Further, the precoding codeword corresponding to each sub-band of the uplink channel may be determined.

In some embodiments, the indication information is configured to indicate the at least one TPMI. A candidate codeword set including at least one precoding codeword may be determined by the terminal device according to the at least one TPMI. Further, the precoding codeword corresponding to each sub-band of the uplink channel may be determined.

In some embodiments, the indication information is configured to indicate the first wideband PMI information, and the number L of the beams included in the first wideband beam group. Alternatively, the indication information is configured to indicate the first wideband PMI information, the number L of the beams included in the first wideband beam group, and the beam forming pattern corresponding to the first wideband beam group. A second sub-band PMI information corresponding to each sub-band of the uplink channel may be determined by the terminal device according to the indication information. Further, the precoding codeword corresponding to each sub-band of the uplink channel may be determined by means of a two-level codebook structure.

Step 203: each corresponding sub-band of the uplink channel is precoded with the precoding codeword corresponding to each sub-band.

Each corresponding sub-band of the uplink channel may be precoded by the terminal device with the precoding codeword corresponding to each sub-band such that the uplink channel can be transported.

Step 204: the uplink channel, of which each sub-band has been precoded, is transmitted to the network device.

Data after precoding may be mapped onto corresponding antenna ports by the terminal device, and the uplink channel, of which each sub-band has been precoded, may be transmitted to the network device.

To sum up, the indication information related to precoding transmitted by the network device is received. The precoding codeword corresponding to each sub-band of the uplink channel is determined according to the indication information. Each corresponding sub-band of the uplink channel is precoded with the precoding codeword corresponding to each sub-band. The uplink channel, of which each sub-band has been precoded, is transmitted to the network device. The disclosure is configured to support uplink transport of 8 layers at most. Each sub-band of the uplink channel of the terminal device is precoded with the corresponding precoding codeword, and frequency selective precoding of uplink transmission of the terminal device is achieved such that the disclosure can better adapt to transmission of a frequency selective channel. Reliability of communication and transport is improved, and overall system performance and efficiency are effectively improved.

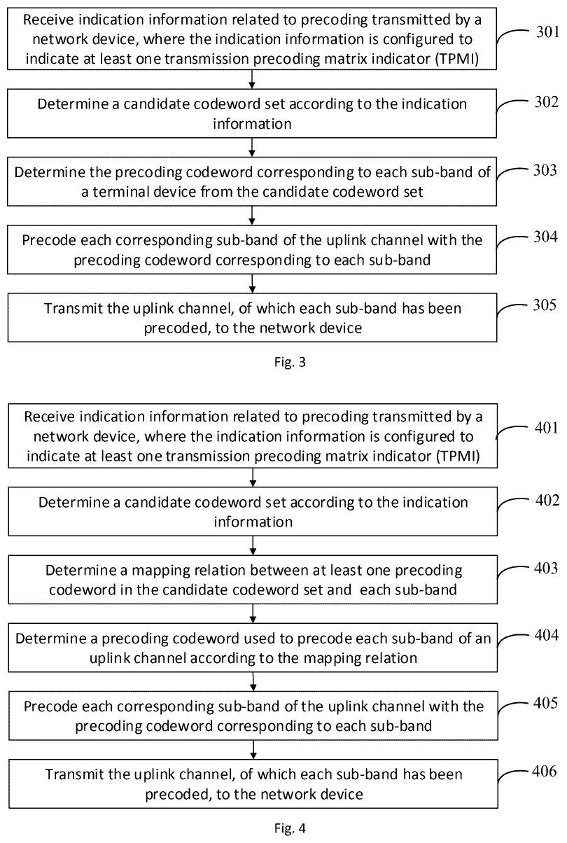

An example of the disclosure provides another transmitting method for an uplink channel. FIG. 3 is a schematic flow diagram of another transmitting method for an uplink channel provided in an example of the disclosure. The method may be executed by the terminal device. The transmitting method for an uplink channel may be executed independently, may be executed in combination with any example of the disclosure or any possible implementation modes in the example, or may be executed in combination with any technical solutions in the related art. As shown in FIG. 3, the transmitting method for an uplink channel may include steps as follows:

Step 301: indication information related to precoding transmitted by a network device is received. The indication information is configured to indicate the at least one transmission precoding matrix indicator (TPMI).

In an example of the disclosure, the indication information related to precoding transmitted by the network device is received by the terminal device, and is configured to indicate the at least one TPMI.

At least one corresponding precoding codeword may be determined by the terminal device from a codebook of the terminal device according to the at least one TPMI.

In some embodiments, the indication information is configured to indicate each TPMI of the at least one TPMI.

That is, the indication information is configured to directly indicate each TPMI. For instance, the indication information is configured to indicate TPMIs having values of m1, m2, m3, etc.

In some embodiments, the indication information is configured to indicate a difference between a value of the at least one TPMI and a reference value.

Optionally, the reference value may be a predefined value, a starting value of at least one TPMI, a value of a minimum TPMI of the TPMI, or a value of a maximum TPMI of the TPMI.

In some embodiments, the indication information is configured to indicate an index of a set including at least one TPMI.

At least one TPMI corresponding to a codebook of the terminal device is grouped according to a preset rule. At least one TPMI set is obtained, and at least one TPMI is included in each TPMI set. The indication information may be configured to indicate an index of the set. At least one TPMI included in the set may be determined according to the index of the set.

Step 302: a candidate codeword set is determined according to the indication information.

In an example of the disclosure, the candidate codeword set may be determined by the terminal according to the indication information.

As described in step 301, at least one TPMI may be determined by the terminal device according to an indication of the indication information.

According to the at least one TPMI, at least one precoding matrix (precoding codeword) in the codebook of the terminal device corresponding to the at least one TPMI may be determined by the terminal device from the codebook of the terminal device. A candidate codeword set is constituted by the at least one precoding matrix (precoding codeword) determined.

In some embodiments, the codebook is a fixed codebook, that is, a codebook which can be acquired by both the network device and the terminal device and is required to be configured for precoding of uplink channel transmission by the terminal device. In an example of the disclosure, the codebook may be generated through a Type I codebook design method, or may be determined through other methods, which is not limited here.

Step 303: the precoding codeword corresponding to each sub-band of a terminal device is determined from the candidate codeword set.

In some embodiments, a number of the sub-bands is greater than a number of the precoding codewords in the candidate codeword set. The sub-bands of the terminal device are divided into at least two cyclic mapping units. Sub-bands in each cyclic mapping unit corresponds to, in sequence of the sub-bands in a corresponding cyclic mapping unit, at least one codeword in the candidate codeword set.

As an instance, the candidate codeword set includes four precoding codewords of which indexes are m0, m1, m2 and m3 respectively. The terminal device includes six sub-bands divided into two cyclic mapping units. A first cyclic mapping unit includes four sub-bands corresponding to the four precoding codewords in sequence. For instance, sub-band 1 corresponds to m0, sub-band 2 corresponds to m1, sub-band 3 corresponds to m2, and sub-band 4 corresponds to m3. Or other corresponding manners are available. For instance, sub-band 1 corresponds to m3, sub-band 2 corresponds to m0, sub-band 3 corresponds to m1, sub-band 4 corresponds to m2, etc. Each sub-band corresponds to a codeword in the candidate codeword set in sequence according to a preset rule. A second cyclic mapping unit includes two sub-bands, and the two sub-bands also correspond to precoding codewords in the candidate codeword set in sequence. For instance, sub-band 5 corresponds to m0, and sub-band 6 corresponds to m1. Or other corresponding manners are available. For instance, sub-band 5 corresponds to m3, and sub-band 6 corresponds to m0, etc. Each sub-band also corresponds to codewords in the candidate codeword set in sequence according to a preset rule. A sequencing rule of the second cyclic mapping unit may be the same as or different from a sequencing rule of the first cyclic mapping unit. Precoding codewords in the candidate codeword set are cyclically mapped onto each sub-band.

In some embodiments, the number of the sub-bands is less than or equal to the number of the precoding codewords in the candidate codeword set. At least one codeword in the candidate codeword set is caused to correspond to each sub-band of the at least one sub-band in sequence.

If the number of the sub-bands is less than or equal to the number of the precoding codewords in the candidate codeword set, at least one codeword in the candidate codeword set is caused to correspond to each sub-band of the at least one sub-band in sequence according to a preset rule. As an instance, the candidate codeword set includes four precoding codewords of which indexes are m0, m1, m2 and m3 respectively. The terminal device includes two sub-bands, and the four codewords in the candidate codeword set correspond to the two sub-bands in sequence. For instance, sub-band 1 corresponds to m0, and sub-band 2 corresponds to m1. Or other corresponding manners are available. For instance, sub-band 1 corresponds to m3, and sub-band 2 corresponds to m0, etc.

Step 304: each corresponding sub-band of the uplink channel is precoded with the precoding codeword corresponding to each sub-band.

Step 305: the uplink channel, of which each sub-band has been precoded, is transmitted to the network device.

In an example of the disclosure, step 304 and step 305 may be implemented through any method in examples of the disclosure, which is not limited in examples of the disclosure, and will not be repeated.

To sum up, the indication information related to precoding transmitted by the network device is received. The indication information is configured to indicate the at least one transmission precoding matrix indicator (TPMI). The candidate codeword set is determined according to the indication information. The precoding codeword corresponding to each sub-band of the determinal device is determined from the candidate codeword set. Each corresponding sub-band of the uplink channel is precoded with the precoding codeword corresponding to each sub-band. The uplink channel, of which each sub-band has been precoded, is transmitted to the network device. The disclosure is configured to support uplink transport of 8 layers at most. Each sub-band of the uplink channel of the terminal device is precoded with the corresponding precoding codeword, and frequency selective precoding of uplink transmission of the terminal device is achieved such that the disclosure can better adapt to transmission of a frequency selective channel. Reliability of communication and transport is improved, and overall system performance and efficiency are effectively improved.

An example of the disclosure provides another transmitting method for an uplink channel. FIG. 4 is a schematic flow diagram of another transmitting method for an uplink channel provided in an example of the disclosure. The method may be executed by the terminal device. The transmitting method for an uplink channel may be executed independently, may be executed in combination with any example of the disclosure or any possible implementation modes in the example, or may be executed in combination with any technical solutions in the related art. As shown in FIG. 4, the transmitting method for an uplink channel may include steps as follows:

Step 401: indication information related to precoding transmitted by a network device is received. The indication information is configured to indicate the at least one transmission precoding matrix indicator (TPMI).

In an example of the disclosure, the indication information related to precoding transmitted by the network device is received by the terminal device, and is configured to indicate the at least one TPMI.

At least one corresponding precoding codeword may be determined by the terminal device from a codebook of the terminal device according to the at least one TPMI.

In some embodiments, the indication information is configured to indicate each TPMI of the at least one TPMI.

That is, the indication information is configured to directly indicate each TPMI. For instance, the indication information is configured to indicate TPMIs having values of m1, m2, m3, etc.

In some embodiments, the indication information is configured to indicate a difference between a value of the at least one TPMI and a reference value.

Optionally, the reference value may be a predefined value, a starting value of at least one TPMI, a value of a minimum TPMI of the TPMI, or a value of a maximum TPMI of the TPMI.

In some embodiments, the indication information is configured to indicate an index of a set including at least one TPMI.

At least one TPMI corresponding to a codebook of the terminal device is grouped according to a preset rule. At least one TPMI set is obtained, and at least one TPMI is included in each TPMI set. The indication information may be configured to indicate an index of the set. At least one TPMI included in the set may be determined according to the index of the set.

Step 402: a candidate codeword set is determined according to the indication information.

In an example of the disclosure, the candidate codeword set may be determined by the terminal according to the indication information.

As described in step 401, at least one TPMI may be determined by the terminal device according to an indication of the indication information.

According to the at least one TPMI, at least one precoding matrix (precoding codeword) in the codebook of the terminal device corresponding to the at least one TPMI may be determined by the terminal device from the codebook of the terminal device. A candidate codeword set is constituted by the at least one precoding matrix (precoding codeword) determined.

In some embodiments, the codebook is a fixed codebook, that is, a codebook which can be acquired by both the network device and the terminal device and is required to be configured for precoding of uplink channel transmission by the terminal device. In an example of the disclosure, the codebook may be generated through a Type I codebook design method, or may be determined through other methods, which is not limited here.

Step 403: a mapping relation between at least one precoding codeword in the candidate codeword set and each sub-band is determined.

In an example of the disclosure, the mapping relation between at least one precoding codeword in the candidate codeword set and each sub-band may be determined by the terminal device. That is, the precoding codeword corresponding to each sub-band may be determined by the terminal device from the at least one precoding codeword included in the candidate codeword set.

Step 404: a precoding codeword used to precode each sub-band of an uplink channel is determined according to the mapping relation.

In an example of the disclosure, the mapping relation between at least one precoding codeword in the candidate codeword set and each sub-band may be determined by the terminal device. The precoding codeword used to precode each sub-band of the uplink channel may be determined according to the mapping relation by the terminal device.

Step 405: each corresponding sub-band of the uplink channel is precoded with the precoding codeword corresponding to each sub-band.

Step 406: the uplink channel, of which each sub-band has been precoded, is transmitted to the network device.

In an example of the disclosure, step 405 and step 406 may be implemented respectively through any method in examples of the disclosure, which is not limited in examples of the disclosure, and will not be repeated.

To sum up, the indication information related to precoding transmitted by the network device is received. The indication information is configured to indicate the at least one transmission precoding matrix indicator (TPMI). The candidate codeword set is determined according to the indication information. The mapping relation between at least one precoding codeword in the candidate codeword set and each sub-band is determined. The precoding codeword used to precode each sub-band of the uplink channel is determined according to the mapping relation. Each corresponding sub-band of the uplink channel is precoded with the precoding codeword corresponding to each sub-band. The uplink channel, of which each sub-band has been precoded, is transmitted to the network device. The disclosure is configured to support uplink transport of 8 layers at most. Each sub-band of the uplink channel of the terminal device is precoded with the corresponding precoding codeword, and frequency selective precoding of uplink transmission of the terminal device is achieved such that the disclosure can better adapt to transmission of a frequency selective channel. Reliability of communication and transport is improved, and overall system performance and efficiency are effectively improved.

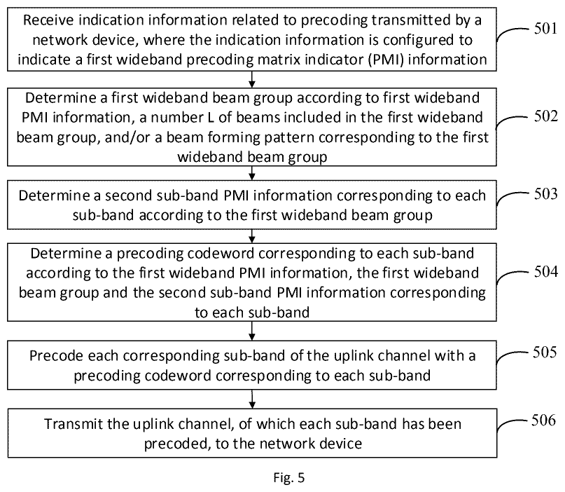

An example of the disclosure provides another transmitting method for an uplink channel. FIG. 5 is a schematic flow diagram of another transmitting method for an uplink channel provided in an example of the disclosure. The method may be executed by the terminal device. The transmitting method for an uplink channel may be executed independently, may be executed in combination with any example of the disclosure or any possible implementation modes in the example, or may be executed in combination with any technical solutions in the related art. As shown in FIG. 5, the transmitting method for an uplink channel may include steps as follows:

Step 501: indication information related to precoding transmitted by a network device is received. The indication information is configured to indicate a first wideband precoding matrix indicator (PMI) information.

In an example of the disclosure, the indication information related to precoding transmitted by the network device is received by the terminal device, and is configured to indicate the first wideband precoding matrix indicator (PMI) information.

The first wideband PMI information may be configured to indicate a group of beam forming vectors. In an example of the disclosure, the codebook satisfies two-level codebook structure W=W₁W₂, and W_{1,i}=[v_{1,i} v_{2,i} . . . v_{N,i}] is a group of forming vectors corresponding to the first wideband PMI information PMIᵢ.

In an example of the disclosure, codebook generation parameters N₁, N₂, O₁, O₂, etc. in the two-level codebook structure may be determined by means of the structure of an antenna array of the terminal device. The relevant parameters may be transmitted to the network device by the terminal device by means of a signaling. Specifically, N₁ and N₂ respectively represent a number of antenna ports in a first dimension in the same polarization direction and a number of antenna ports in a second dimension in the same polarization direction of the terminal device respectively, and O₁ and O₂ respectively represent oversampling multiples of DFT vectors in the first dimension and the second dimension.

In some embodiments, the indication information may be further configured to indicate a number L of beams included in a first wideband beam group, or may be configured to indicate the number L of the beams included in the first wideband beam group and the beam forming pattern corresponding to the first wideband beam group.

Step 502: a first wideband beam group is determined according to first wideband PMI information, the number L of beams included in the first wideband beam group, and/or a beam forming pattern corresponding to the first wideband beam group.

In an example of the disclosure, the first wideband beam group is determined by the terminal device according to the first wideband PMI information and the number L of the beams included in the first wideband beam group. Alternatively, the first wideband beam group is determined according to the first wideband PMI information, the number L of the beams included in the first wideband beam group, and the beam forming pattern corresponding to the first wideband beam group.

The number L of the beams included in the first wideband beam group refers to a number of beams in diagonal block matrix B in a first-level codebook of two-level codebook structure W=W₁W₂, where

$${W}_{1} = [ \begin{matrix}B & 0 \\ 0 & B\end{matrix} ] .$$

In a case of L>1, the beam forming pattern corresponding to the first wideband beam group also is required to be determined.

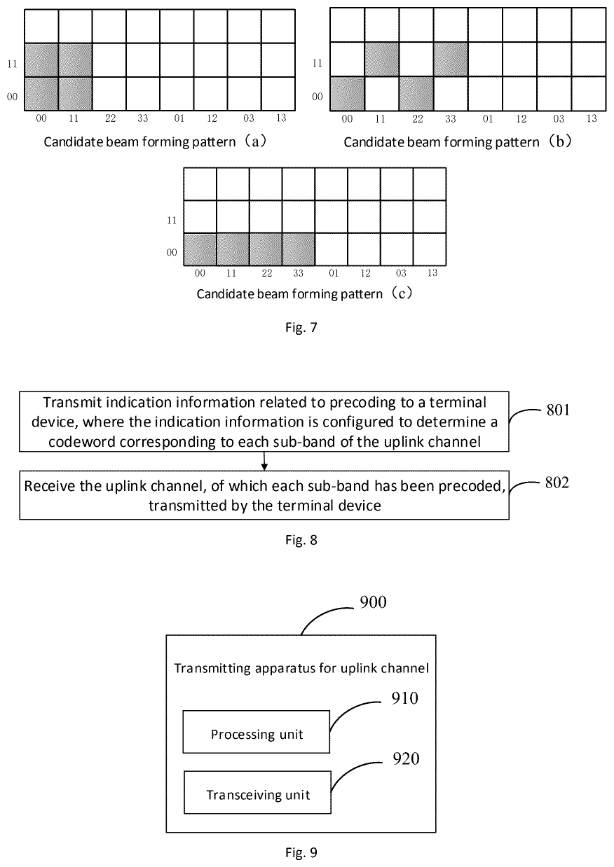

As an instance, in a case of L=4, with reference to FIG. 7, a schematic diagram of a beam forming pattern according to an example of the disclosure is shown in FIG. 7. Possible beam forming patterns of the first wideband beam group are shown in FIG. 7. A corresponding pattern is required to be selected by the terminal device from candidate beam forming patterns of the first wideband beam group.

It can be understood that in an example of the disclosure, other candidate beam forming patterns may be designed according to different number of beams included in the first wideband beam group, which is not limited here.

Optionally, the number L of the beams included in the first wideband beam group may be predefined, or may be indicated by indication information transmitted by the network device. Similarly, in a case of L>1, the beam forming pattern corresponding to the first wideband beam group of the terminal device may also be predefined, or may be indicated by indication information transmitted by the network device.

Step 503: a second sub-band PMI information corresponding to each sub-band is determined according to the first wideband beam group.

The second sub-band PMI information is configured to select beams from the first wideband beam group.

In some embodiments, the number of the beams included in the first wideband beam group is L=1. The second sub-band PMI information corresponding to each sub-band may be determined according to the first wideband beam group.

In some embodiments, the number of the beams included in the first wideband beam group is L>1. In predefined sequence or in sequence indicated by a signaling, a beam corresponding to each sub-band is determined from a plurality of beams in the first wideband beam group. Further, the second sub-band PMI information corresponding to each sub-band is determined according to the beam corresponding to each sub-band.

According to sequence of any beam in the first wideband beam group and the number L of the beams included in the first wideband beam group, a sub-band position corresponding to the beam may be determined by the terminal device.

That is, a beam in the first wideband beam group corresponding to each sub-band may be determined by the terminal device in sequence. Optionally, the sequence may be predefined, or may be indicated by the network device by means of a signaling.

Optionally, the beams in the first wideband beam group may cyclically correspond to each sub-band. As an instance, the first wideband beam group includes four beams, index numbers of which are b0, b1, b2 and b3 respectively. The terminal device includes six sub-bands. The beam corresponding to each sub-band is determined in sequence as follows: sub-band 1 corresponds to beam b0, sub-band 2 corresponds to beam b1, sub-band 3 corresponds to beam b2, sub-band 4 corresponds to beam b3, sub-band 5 corresponds to beam b4, and sub-band 6 corresponds to beam b5. Other sequence may also be available. For instance, sub-band 1 corresponds to beam b0, sub-band 2 corresponds to beam b2, sub-band 3 corresponds to beam b3, sub-band 4 corresponds to beam b1, sub-band 5 corresponds to beam b0, sub-band 6 corresponds to beam b2, etc.

Step 504: a precoding codeword corresponding to each sub-band is determined according to the first wideband PMI information, the first wideband beam group and the second sub-band PMI information corresponding to each sub-band.

In an example of the disclosure, the precoding codeword corresponding to each sub-band may be determined by the terminal device according to the first wideband PMI information, the first wideband beam group and the second sub-band PMI information corresponding to each sub-band in a manner of a two-level codebook structure.

Step 505: each corresponding sub-band of the uplink channel is precoded with the precoding codeword corresponding to each sub-band.

Step 506: the uplink channel, of which each sub-band has been precoded, is transmitted to the network device.

In an example of the disclosure, step 505 and step 506 may be implemented through any method in examples of the disclosure, which is not limited in examples of the disclosure, and will not be repeated.

To sum up, the indication information related to precoding transmitted by the network device is received. The indication information is configured to indicate the first wideband precoding matrix indicator (PMI) information. The first wideband beam group is determined according to the first wideband PMI information, the number L of the beams included in the first wideband beam group, and/or the beam forming pattern corresponding to the first wideband beam group. The second sub-band PMI information corresponding to each sub-band is determined according to the first wideband beam group. The precoding codeword corresponding to each sub-band is determined according to the first wideband PMI information, the first wideband beam group, and the second sub-band PMI information corresponding to each sub-band. Each corresponding sub-band of the uplink channel is precoded with the precoding codeword corresponding to each sub-band. The uplink channel, of which each sub-band has been precoded, is transmitted to the network device. The disclosure is configured to support uplink transport of 8 layers at most. Each sub-band of the uplink channel of the terminal device is precoded with the corresponding precoding codeword, and frequency selective precoding of uplink transmission of the terminal device is achieved such that the disclosure can better adapt to transmission of a frequency selective channel. Reliability of communication and transport is improved, and overall system performance and efficiency are effectively improved.

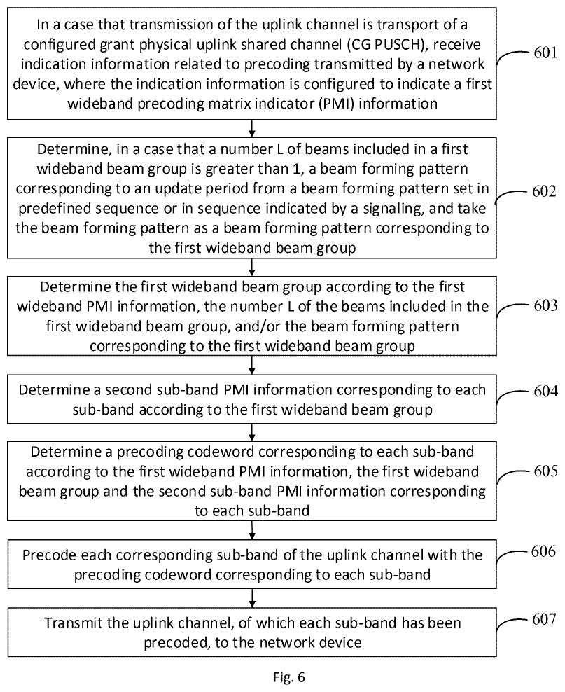

An example of the disclosure provides another transmitting method for an uplink channel. FIG. 6 is a schematic flow diagram of another transmitting method for an uplink channel provided in an example of the disclosure. The method may be executed by the terminal device. The transmitting method for an uplink channel may be executed independently, may be executed in combination with any example of the disclosure or any possible implementation modes in the example, or may be executed in combination with any technical solutions in the related art. As shown in FIG. 6, the transmitting method for an uplink channel may include steps as follows:

Step 601: in a case that transmission of the uplink channel is transmission of a configured grant physical uplink shared channel (CG PUSCH), indication information related to precoding transmitted by a network device is received. The indication information is configured to indicate a first wideband precoding matrix indicator (PMI) information.

In an example of the disclosure, the transmission of the uplink channel is the transmission of the configured grant physical uplink shared channel (CG PUSCH). The transmission of the uplink channel has a plurality of update periods, and a PUSCH is transmitted in each update period.

In an example of the disclosure, the indication information related to precoding transmitted by the network device is received by the terminal device, and is configured to indicate the first wideband precoding matrix indicator (PMI) information.

The first wideband PMI information may be configured to indicate a group of beam forming vectors. In an example of the disclosure, the codebook satisfies two-level codebook structure W=W₁W₂, and W_{1,i}=[v_{1,i} v_{2,i} . . . v_{N,i}] is a group of forming vectors corresponding to the first wideband PMI information PMIᵢ.

In an example of the disclosure, codebook generation parameters N₁, N₂, O₁, O₂, etc. in the two-level codebook structure may be determined by means of the structure of an antenna array of the terminal device. The relevant parameters may be transmitted to the network device by the terminal device by means of a signaling. Specifically, N₁ and N₂ respectively represent a number of antenna ports in a first dimension in the same polarization direction and a number of antenna ports in a second dimension in the same polarization direction of the terminal device respectively, and O₁ and O₂ respectively represent oversampling multiples of DFT vectors in the first dimension and the second dimension respectively.

In some embodiments, the indication information may be further configured to indicate a number L of beams included in a first wideband beam group, or may be configured to indicate a number L of beams included in a first wideband beam group and the beam forming pattern corresponding to the first wideband beam group.

Step 602: in a case that the number L of the beams included in the first wideband beam group is greater than 1, a beam forming pattern corresponding to an update period from a beam forming pattern set is determined in predefined sequence or in sequence indicated by a signaling, and the beam forming pattern is taken as the beam forming pattern corresponding to the first wideband beam group.

In an example of the disclosure, the number L of the beams included in the first wideband beam group is greater than 1. The beam forming pattern corresponding to the first wideband beam group is further required to be determined by the terminal device.

As an instance, in a case of L=4, with reference to FIG. 7, a schematic diagram of a beam forming pattern according to an example of the disclosure is shown in FIG. 7. Possible beam forming patterns of the first wideband beam group are shown in FIG. 7. A corresponding pattern is required to be selected by the terminal device from candidate beam forming patterns of the first wideband beam group.

Optionally, the number L of the beams included in the first wideband beam group may be predefined, or may be indicated by indication information transmitted by the network device. Similarly, the beam forming pattern corresponding to the first wideband beam group of the terminal device may also be predefined, or may be indicated by indication information transmitted by the network device.

In some embodiments, a beam forming pattern corresponding to the update period is determined by the terminal device in sequence from a beam forming pattern set composed of the at least one candidate beam forming pattern, and serves as the beam forming pattern corresponding to the first wideband beam group such that the PUSCH can be transmitted in the update period.

Optionally, the sequence may be predefined, or may be indicated by indication information transmitted by the network device. As an instance, L=4, and the beam forming pattern set may include three candidate beam forming patterns as shown in FIG. 7. The terminal device may determine that a beam forming pattern corresponding to the first wideband beam group in a first update period is (a) in FIG. 7, a beam forming pattern corresponding to the first wideband beam group in a second update period is (b) in FIG. 7, a beam forming pattern corresponding to the first wideband beam group in a third update period is (c) in FIG. 7, a beam formation pattern corresponding to the first wideband beam group in a fourth update period is (a) in FIG. 7, etc.

Optionally, the beam forming patterns in the beam forming pattern set may cyclically correspond to an update period.

It can be understood that in an example of the disclosure, other beam forming patterns may be designed in the beam forming pattern set according to different numbers of beams included in the first wideband beam group, which is not limited here.

Step 603: the first wideband beam group is determined according to the first wideband PMI information, the number L of the beams included in the first wideband beam group, and the beam forming pattern corresponding to the first wideband beam group.

In an example of the disclosure, the first wideband beam group is determined by the terminal device according to the first wideband PMI information, the number L of the beams included in the first wideband beam group, and the beam forming pattern corresponding to the first wideband beam group.

Step 604: second sub-band PMI information corresponding to each sub-band is determined according to the first wideband beam group.

The second sub-band PMI information is configured to select beams from the first wideband beam group.

In some embodiments, the number of the beams included in the first wideband beam group is L>1. In predefined sequence or in sequence indicated by a signaling, a beam corresponding to each sub-band is determined from a plurality of beams in the first wideband beam group. Further, the second sub-band PMI information corresponding to each sub-band is determined according to the beam corresponding to each sub-band.

According to sequence of any beam in the first wideband beam group and the number L of the beams included in the first wideband beam group, a sub-band position corresponding to the beam may be determined by the terminal device.

That is, a beam in the first wideband beam group corresponding to each sub-band may be determined by the terminal device in sequence. Optionally, the sequence may be predefined, or may be indicated by the network device by means of a signaling.

Optionally, the beams in the first wideband beam group may cyclically correspond to each sub-band. As an instance, the first wideband beam group includes four beams, index numbers of which are b0, b1, b2 and b3 respectively. The terminal device includes six sub-bands. The beam corresponding to each sub-band is determined in sequence as follows: sub-band 1 corresponds to beam b0, sub-band 2 corresponds to beam b1, sub-band 3 corresponds to beam b2, sub-band 4 corresponds to beam b3, sub-band 5 corresponds to beam b4, and sub-band 6 corresponds to beam b5. Other sequence may also be available. For instance, sub-band 1 corresponds to beam b0, sub-band 2 corresponds to beam b2, sub-band 3 corresponds to beam b3, sub-band 4 corresponds to beam b1, sub-band 5 corresponds to beam b0, sub-band 6 corresponds to beam b2, etc.

Step 605: a precoding codeword corresponding to each sub-band is determined according to the first wideband PMI information, the first wideband beam group and the second sub-band PMI information corresponding to each sub-band.

In an example of the disclosure, the precoding codeword corresponding to each sub-band may be determined by the terminal device according to the first wideband PMI information, the first wideband beam group and the second sub-band PMI information corresponding to each sub-band in a manner of a two-level codebook structure.

Step 606: each corresponding sub-band of the uplink channel is precoded with the precoding codeword corresponding to each sub-band.

Step 607: the uplink channel, of which each sub-band has been precoded, is transmitted to the network device.

In an example of the disclosure, step 606 and step 607 may be implemented through any method in examples of the disclosure, which is not limited in examples of the disclosure, and will not be repeated.

To sum up, the transmission of the uplink channel is the transport of the configured grant physical uplink shared channel (CG PUSCH). The indication information related to precoding transmitted by the network device is received. The indication information is configured to indicate the first wideband precoding matrix indicator (PMI) information. The number L of the beams included in the first wideband beam group is greater than 1. The beam forming pattern corresponding to the update period is determined from the beam forming pattern set in predefined sequence or in sequence indicated by a signaling. The beam forming pattern is taken as the beam forming pattern corresponding to the first wideband beam group. The first wideband beam group is determined according to the first wideband PMI information, the number L of the beams included in the first wideband beam group, and the beam forming pattern corresponding to the first wideband beam group. The second sub-band PMI information corresponding to each sub-band is determined according to the first wideband beam group. The precoding codeword corresponding to each sub-band is determined according to the first wideband PMI information, the first wideband beam group and the second sub-band PMI information corresponding to each sub-band. Each corresponding sub-band of the uplink channel is precoded with the precoding codeword corresponding to each sub-band. The uplink channel, of which each sub-band has been precoded, is transmitted to the network device. The disclosure is configured to support uplink transport of 8 layers at most. Each sub-band of the uplink channel of the terminal device is precoded with the corresponding precoding codeword, and frequency selective precoding of uplink transmission of the terminal device is achieved such that the disclosure can better adapt to transmission of a frequency selective channel. Reliability of communication and transport is improved, and overall system performance and efficiency are effectively improved.

An example of the disclosure provides another receiving method for an uplink channel. FIG. 8 is a schematic flow diagram of a receiving method for an uplink channel according to an example of the disclosure. It should be noted that the method in an example of the disclosure is executed by a network device. As shown in FIG. 8, the receiving method for an uplink channel may include steps as follows:

Step 801: indication information related to precoding is transmitted to a terminal device. The indication information is configured to determine a codeword corresponding to each sub-band of the uplink channel.

In an example of the disclosure, the indication information related to precoding is transmitted to the terminal device by the network device. The indication information related to precoding transmitted by the network device may be received by the terminal device. The precoding codeword corresponding to each sub-band of the uplink channel may be determined according to the indication information.

In an example of the disclosure, optionally, the uplink channel may be a physical uplink shared channel (PUSCH).

Optionally, the indication information is configured to indicate at least one of:

at least one transmission precoding matrix indicator (TPMI); a first wideband precoding matrix indicator (PMI) information; a number L of beams included in a first wideband beam group; a beam forming pattern corresponding to the first wideband beam group; channel state information (CSI) including PMI information of at least one sub-band; and part of channel state information (CSI).

In some embodiments, the indication information is configured to indicate the first wideband PMI information and the channel state information (CSI) including precoding information of at least one sub-band. The precoding codeword corresponding to each sub-band of the uplink channel of the terminal device may be directly determined by the terminal device according to the channel state information (CSI) indication including precoding information of at least one sub-band and the first wideband PMI information. Optionally, the indication information may be carried in downlink control information (DCI).

In some embodiments, the indication information is configured to indicate part of channel state information (CSI). As an instance, the part of the CSI information is a transmission rank indicator (TRI). Precoding information of a wideband and a sub-band may be determined by the terminal device according to the part of the CSI and by combining a precoding matrix estimated by the terminal device with part of the CSI fed back by the network device. Further, the precoding codeword corresponding to each sub-band of the uplink channel may be determined.

In some embodiments, the indication information is configured to indicate the first wideband PMI information, and the number L of the beams included in the first wideband beam group. Alternatively, the indication information is configured to indicate the first wideband PMI information, the number L of the beams included in the first wideband beam group, and the beam forming pattern corresponding to the first wideband beam group. A second sub-band PMI information corresponding to each sub-band of the uplink channel may be determined by the terminal device according to the indication information. Further, the precoding codeword corresponding to each sub-band of the uplink channel may be determined by means of a two-level codebook structure.

In some embodiments, the indication information is configured to indicate the at least one TPMI. The at least one TPMI is configured to determine a candidate codeword set including at least one precoding codeword. The precoding codeword corresponding to each sub-band of the uplink channel is a precoding codeword in the candidate codeword set. That is, a candidate codeword set including at least one precoding codeword may be determined by the terminal device according to the at least one TPMI. Further, the precoding codeword corresponding to each sub-band of the uplink channel may be determined.

Optionally, in some embodiments, the indication information is configured to indicate each TPMI of the at least one TPMI.

That is, the indication information is configured to directly indicate each TPMI. For instance, the indication information is configured to indicate TPMIs having values of m1, m2, m3, etc.

In some embodiments, the indication information is configured to indicate a difference between a value of at least one TPMI and a reference value.

Optionally, the reference value may be a predefined value, a starting value of at least one TPMI, a value of a minimum TPMI of the TPMI, or a value of a maximum TPMI of the TPMI.

In some embodiments, the indication information is configured to indicate an index of a set including at least one TPMI.

At least one TPMI corresponding to a codebook of the terminal device is grouped according to a preset rule. At least one TPMI set is obtained, and at least one TPMI is included in each TPMI set. The indication information may be configured to indicate an index of the set. At least one TPMI included in the set may be determined according to the index of the set.

Step 802: the uplink channel, of which each sub-band has been precoded, transmitted by the terminal device is received.

After the precoding codeword of each sub-band is determined by the terminal device, each corresponding sub-band of the uplink channel may be precoded with the precoding codeword corresponding to each sub-band. Data after precoding may be mapped onto corresponding antenna ports by the terminal device, and the uplink channel, of which each sub-band has been precoded, may be transmitted to the network device.

In an example of the disclosure, the uplink channel, of which each sub-band has been precoded, transmitted by the terminal device may be received by the network device, such that the uplink channel is transmitted.

To sum up, the indication information related to precoding is transmitted to a terminal device. The indication information is configured to determine the codeword corresponding to each sub-band of the uplink channel. The uplink channel, of which each sub-band has been precoded, transmitted by the terminal device is received. The disclosure is configured to support uplink transport of 8 layers at most. Each corresponding sub-band of the uplink channel of the terminal device is precoded with the corresponding precoding codeword, and frequency selective precoding of uplink transmission of the terminal device is achieved such that the disclosure can better adapt to transmission of a frequency selective channel. Reliability of communication and transport is improved, and overall system performance and efficiency are effectively improved.

In the above examples provided in the disclosure, the method provided in examples of the disclosure is introduced from the perspectives of a network device and a terminal device respectively. In order to implement all functions in the method provided in the above examples of the disclosure, the network device and the terminal device may include a hardware structure and a software module. The above functions are implemented by the hardware structure, the software module, or the hardware structure and the software module. One of the above functions may be executed by the hardware structure, the software module, or the hardware structure and the software module.

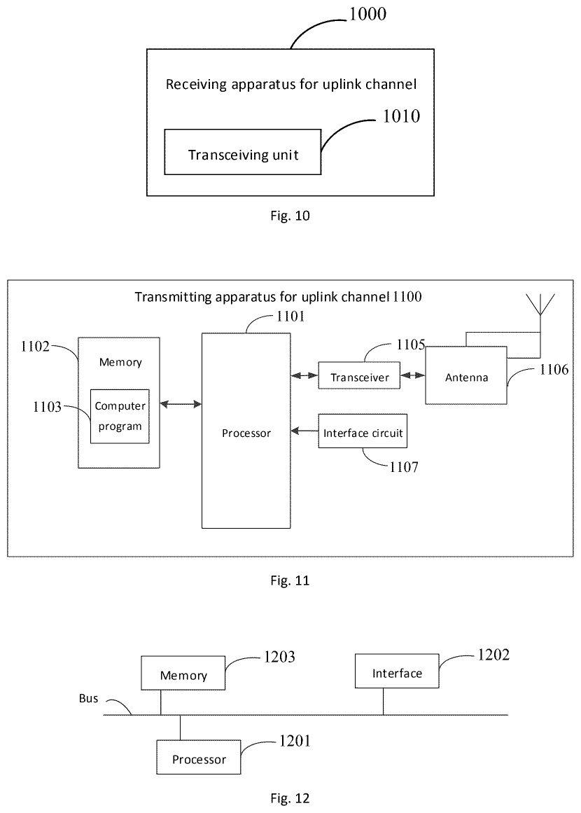

The disclosure further provides a transmitting apparatus for an uplink channel corresponding to the transmitting method for an uplink channel provided in the above examples. Since the transmitting apparatus for an uplink channel provided in examples of the disclosure corresponds to the method provided in the above examples, the embodiment of the transmitting method for an uplink channel is also applicable to the transmitting apparatus for an uplink channel provided in the example, which will not be described in detail in the example. FIGS. 9 and 10 are schematic structural diagrams of a transmitting apparatus for an uplink channel and a receiving apparatus for an uplink channel according to the disclosure.

FIG. 9 is a schematic structural diagram of a transmitting apparatus for an uplink channel according to an example of the disclosure. The apparatus is applied to a terminal device.

As shown in FIG. 9, the transmitting apparatus for an uplink channel 900 includes a transceiving unit 920 and a processing unit 910.

The transceiving unit 920 is configured to receive indication information related to precoding transmitted by a network device.

The processing unit 910 is configured to determine a precoding codeword corresponding to each sub-band of the uplink channel according to the indication information.

The processing unit 910 is configured to precode each corresponding sub-band of the uplink channel with the precoding codeword corresponding to each sub-band.

The transceiving unit 920 is configured to transmit the uplink channel, of which each sub-band has been precoded, to the network device.

As an implementation mode of an example of the disclosure, the indication information is configured to indicate at least one of:
at least one transmission precoding matrix indicator (TPMI);
a first wideband precoding matrix indicator (PMI) information;
a number L of beams included in a first wideband beam group, where L is a positive integer;
a beam forming pattern corresponding to the first wideband beam group;
channel state information (CSI) including PMI information of at least one sub-band; and
part of channel state information (CSI).

As an implementation mode of an example of the disclosure, the indication information is configured to indicate the at least one transmission precoding matrix indicator (TPMI). The processing unit 910 is specifically configured to:
determine a candidate codeword set according to the indication information; and
determine a precoding codeword corresponding to each sub-band of the uplink channel from the candidate codeword set.

As an implementation mode of an example of the disclosure, a number of the sub-bands is greater than a number of the precoding codewords in the candidate codeword set. The processing unit 910 is specifically configured to:
map cyclically at least one codeword in the candidate codeword set onto each sub-band in sequence.

As an implementation mode of an example of the disclosure, a number of the sub-bands is less than or equal to a number of the precoding codewords in the candidate codeword set. The processing unit 910 is specifically configured to:
cause at least one codeword in the candidate codeword set to correspond to each of the at least one sub-band in sequence.

As an implementation mode of an example of the disclosure, the indication information is configured to indicate the at least one TPMI. The processing unit 910 is specifically configured to:
determine a mapping relation between at least one precoding codeword in the candidate codeword set and each sub-band; and
determine the precoding codeword used to precode each sub-band of the uplink channel according to the mapping relation.

As an implementation mode of an example of the disclosure, the indication information is further configured to indicate at least one of:
a difference between the at least one TPMI and a reference value; and
an index of a set including the at least one TPMI.

As an implementation mode of an example of the disclosure, the indication information is configured to indicate the first wideband precoding matrix indicator (PMI) information. The processing unit 910 is specifically configured to:
determine the first wideband beam group according to the first wideband PMI information, the number L of the beams included in the first wideband beam group, and/or the beam forming pattern corresponding to the first wideband beam group;
determine a second sub-band PMI information corresponding to each sub-band according to the first wideband beam group; and
determine the precoding codeword corresponding to each sub-band according to the first wideband PMI information, the first wideband beam group and the second sub-band PMI information corresponding to each sub-band.

As an implementation mode of an example of the disclosure, the number L of the beams included in the first wideband beam group is greater than 1. The processing unit 910 is specifically configured to:
determine, in predefined sequence or in sequence indicated by a signaling, a beam corresponding to each sub-band from a plurality of beams in the first wideband beam group; and
determine the second sub-band PMI information corresponding to each sub-band according to the beam corresponding to each sub-band.

As an implementation mode of an example of the disclosure, the processing unit 910 is specifically configured to:
determine, according to sequence of any beam in the first wideband beam group and the number L of the beams included in the first wideband beam group, a sub-band position corresponding to the beam.

As an implementation mode of an example of the disclosure, transmission of the uplink channel is transmission of a configured grant physical uplink shared channel (CG PUSCH). The processing unit 910 is further configured to:

determine, in a case that the number L of the beams included in the first wideband beam group is greater than 1, a beam forming pattern corresponding to an update period from a beam forming pattern set in predefined sequence or in sequence indicated by a signaling, and take the beam forming pattern as the beam forming pattern corresponding to the first wideband beam group.

As an implementation mode of an example of the disclosure, the indication information is configured to indicate the first wideband PMI information, and the channel state information (CSI) including precoding information of at least one sub-band.

As an implementation mode of an example of the disclosure, the indication information is configured to indicate the first wideband PMI information. The transceiving unit920 is further configured to transmit a codebook generation parameter to the network device.

According to the apparatus in an example of the disclosure, the indication information related to precoding transmitted by the network device is received. The precoding codeword corresponding to each sub-band of the uplink channel is determined according to the indication information. Each corresponding sub-band of the uplink channel is precoded with the precoding codeword corresponding to each sub-band. The uplink channel, of which each sub-band has been precoded, is transmitted to the network device. The disclosure is configured to support uplink transport of 8 layers at most. Each sub-band of the uplink channel of the terminal device is precoded with the corresponding precoding codeword, and frequency selective precoding of uplink transmission of the terminal device is achieved such that the disclosure can better adapt to transmission of a frequency selective channel. Reliability of communication and transport is improved, and overall system performance and efficiency are effectively improved.

FIG. 10 is a schematic structural diagram of another receiving apparatus for an uplink channel according to an example of the disclosure.

As shown in FIG. 10, the receiving apparatus 1000 for an uplink channel includes a transceiving unit 1010.

The transceiving unit 1010 is configured to transmit indication information related to precoding to a terminal device. The indication information is configured to determine a codeword corresponding to each sub-band of the terminal device.

The transceiving unit 1010 is configured to receive the uplink channel, of which each sub-band has been precoded, transmitted by the terminal device.

As an implementation mode of an example of the disclosure, the indication information is configured to indicate at least one of:
at least one transmission precoding matrix indicator (TPMI);
a first wideband precoding matrix indicator (PMI) information;
a number L of beams included in a first wideband beam group, where L is a positive integer;
a beam forming pattern corresponding to the first wideband beam group;
channel state information (CSI) including PMI information of at least one sub-band; and
part of channel state information (CSI).

As an implementation mode of an example of the disclosure, the indication information is configured to indicate the at least one transmission precoding matrix indicator (TPMI). The at least one transmission precoding matrix indicator (TPMI) is configured to determine a candidate codeword set. The precoding codeword corresponding to each sub-band of the terminal device is a precoding codeword in the candidate codeword set.

As an implementation mode of an example of the disclosure, the indication information is further configured to indicate at least one of:
a difference between the at least one TPMI and a reference value; and
an index of a set including the at least one TPMI.

As an implementation mode of an example of the disclosure, the indication information is configured to indicate the first wideband PMI information, and the channel state information (CSI) including precoding information of at least one sub-band.

As an implementation mode of an example of the disclosure, the indication information is configured to indicate the first wideband PMI information. The transceiving unit 1010 is further configured to receive a codebook generation parameter transmitted by the terminal device.

According to the apparatus in an example of the disclosure, the indication information related to precoding is transmitted to the terminal device. The indication information is configured to determine the codeword corresponding to each sub-band of the uplink channel. The uplink channel, of which each sub-band has been precoded, transmitted by the terminal device is received. The disclosure is configured to support uplink transport of 8 layers at most. Each sub-band of the uplink channel of the terminal device is precoded with the corresponding precoding codeword, and frequency selective precoding of uplink transmission of the terminal device is achieved such that the disclosure can better adapt to transmission of a frequency selective channel. Reliability of communication and transport is improved, and overall system performance and efficiency are effectively improved.

With reference to FIG. 11, a schematic structural diagram of a transmitting apparatus for an uplink channel according to an example of the disclosure is shown in FIG. 11. The transmitting apparatus 1100 for an uplink channel may be a network device, may be a terminal device, may be a chip, a chip system or a processor, etc. that supports the network device in implementation of the above method, may be a chip, a chip system or a processor, etc. that supports the terminal device in implementation of the above method. The apparatus may be configured to implement the method described in the above method examples, and details can be obtained with reference to the descriptions in the above method examples.

The transmitting apparatus 1100 for an uplink channel may include one or more processors 1101. The processor 1101 may be a general-purpose processor or a special-purpose processor, etc. For instance, the processor may be a baseband processor or a central processing unit. The baseband processor may be configured to process communication protocols and communication data. The central processing unit may be configured to control a transmitting apparatus (such as a base station, a baseband chip, a terminal device, a terminal device chip, a distributed unit (DU) or a centralized unit (CU)) for an uplink channel, execute a computer program, and process data of the computer program.

Optionally, one or more memories 1102 may be included in the transmitting apparatus 1100 for an uplink channel. A computer program 1103 may be stored in the memory. The processor 1101 executes the computer programs 1103 to cause the transmitting apparatus 1100 for an uplink channel to execute the method described in the above method examples. The computer program 1103 may be embedded in the processor 1101. In this case, the processor 1101 may be implemented by hardware.

Optionally, data may be stored in the memory 1102. The transmitting apparatus 1100 for an uplink channel and the memory 1102 may be arranged separately or may be integrated together.

Optionally, the transmitting apparatus 1100 for an uplink channel may further include a transceiver 1105 and an antenna 1106. The transceiver 1105 may be referred to as a transceiving unit, a transceiver, or a transceiving circuit, and is configured to implement a transceiving function. The transceiver 1105 may include a receiver and a transmitter. The receiver may be referred to as a receiver or a receiving circuit, etc., and is configured to implement a receiving function. The transmitter may be referred to as a transmitter or a transmitting circuit, etc., and is configured to implement a transmitting function.

Optionally, the transmitting apparatus 1100 for an uplink channel may further include one or more interface circuits 1107. The interface circuit 1107 is configured to receive a code instruction and transmit the code instruction to the processor 1101. The processor 1101 executes the code instruction to cause the transmitting apparatus 1100 for an uplink channel to execute the method described in the above method examples.

In an implementation mode, the processor 1101 may include a transceiver configured to implement receiving and transmitting functions. For instance, the transceiver may be a transceiving circuit, an interface or an interface circuit. The transceiving circuit, the interface or the interface circuit, which is configured to implement receiving and transmitting functions, may be separate or integrated. The transceiving circuit, the interface or the interface circuit mentioned above may be configured to read and write code/data, or the transceiving circuit, the interface or the interface circuit may be configured to transport or transfer a signal.

In an implementation mode, the transmitting apparatus 1100 for an uplink channel may include a circuit. The circuit may implement the transmitting, receiving or communication function in the above method example. The processor and transceiver described in the disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and transceiver may also be fabricated through various IC process technologies, such as a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs), etc.

The transmitting apparatus for an uplink channel described in the above examples may be a network device or a terminal device, but the scope of the transmitting apparatus for an uplink channel described in the disclosure is not limited to this. Moreover, the structure of the transmitting apparatus for an uplink channel may not be limited by FIGS. 9 and 10. The transmitting apparatus for an uplink channel may be a stand-alone device or may be a part of a large device. For instance, the transmitting apparatus for an uplink channel may be as follows:
(1) an independent integrated circuit (IC), a chip, a chip system or a subsystem;
(2) a set of one or more ICs, where optionally, the IC set may also include a memory component configured to store data and a computer program;
(3) an ASIC, such as a modem;
(4) a module that can be embedded in another device;
(5) a receiver, a terminal device, an intelligent terminal device, a cellular phone, a wireless device, a handset, a mobile unit, a vehicle-mounted device, a network device, a cloud device, an artificial intelligence device, etc.; and
(6) a different one.

A case that the transmitting apparatus for an uplink channel may be a chip or a chip system can be obtained with reference to the schematic structural diagram of a chip shown in FIG. 12. The chip shown in FIG. 12 includes a processor 1201 and an interface 1202. One or more processors 1201 may be arranged, and a plurality of interfaces 1202 may be arranged.

In a case that the chip is configured to implement functions of a network device in an example of the disclosure,
the interface 1202 is configured to receive a code instruction and to transmit the code instruction to the processor; and
the processor 1201 is configured to run the code instruction to execute the method as shown in FIGS. 2-6.

In a case that the chip is configured to implement functions of a terminal device in an example of the disclosure,
the interface 1202 is configured to receive a code instruction and to transmit the code instruction to the processor; and
the processor 1201 is configured to run the code instruction to execute the method as shown in FIG. 8.

Optionally, the chip further includes a memory 1203. The memory 1203 is configured to store a necessary computer program and data.

Those skilled in the art will further recognize that various illustrative logical blocks and steps listed in examples of the disclosure may be implemented by electronic hardware, computer software, or their combinations. Whether such functions are implemented by hardware or software depends on particular application and design requirements of the entire system. Those skilled in the art may implement functions through various methods for each type of specific application. However, such implementation should not be understood as falling beyond the scope of protection of examples of the disclosure.

An example of the disclosure further provides a communication system. The system includes a transmitting apparatus for an uplink channel which serves as a terminal device and a receiving apparatus for an uplink channel which serves as a network device in the foregoing examples of FIGS. 9 and 10. Alternatively, the system includes a transmitting apparatus for an uplink channel which serves as a terminal device and a transmitting apparatus for an uplink channel which serves as a network device in the example of FIG. 11.

The disclosure further provides a readable storage medium. An instruction is stored in the readable storage medium. The instruction implements functions of any one of the above method examples when executed by a computer.

The disclosure further provides a computer program product. The computer program product implements functions of any one of the above method examples when executed by a computer.

All or some of the above examples may be implemented by software, hardware, firmware, or their combinations. In a case of implementation by software, implementation in a form of entire or partial computer program product is possible. The computer program product includes one or more computer programs. When the computer program is loaded and executed on a computer, all or some of flows or functions according to examples of the disclosure are generated. The computer may be a general-purpose computer, a dedicated computer, a computer network, or another programmable apparatus. The computer program may be stored in a computer-readable storage medium or may be transmitted from a computer-readable storage medium to another computer-readable storage medium. For instance, the computer program may be transmitted from a website, computer, server, or data center to another website, computer, server, or data center in a wired manner (for instance, through a coaxial cable, an optical fiber, or a digital subscriber line (DSL)) or a wireless manner (for instance, through infrared rays, radio, or microwave). The computer-readable storage medium may be any available medium that can be accessed by the computer, or a data storage device, such as a server or a data center in which one or more available mediums are integrated. The available medium may be a magnetic medium (such as a floppy disk, a hard disk and a magnetic tape), an optical medium (such as a digital video disc (DVD)), or a semiconductor medium (such as a solid state disk (SSD)), etc.

Those of ordinary skill in the art can understand that various numerical numbers such as first and second involved in the disclosure are merely used for convenience of description, are not intended to limit the scope of examples of the disclosure, and further indicate sequence.

At least one in the disclosure may also be described as one or more, and a plurality of may be described as two, three, four, or more, which is not limited in the disclosure. In an example of the disclosure, technical features of a kind of technical features are distinguished by “first”, “second”, “third”, “A”, “B”, “C”, and “D”, and the technical features described by “first”, “second”, “third”, “A”, “B”, “C”, and “D” are not in priority sequence or size sequence.

Corresponding relations shown in the tables in the disclosure may be configured or predefined. The values of information in each table are merely instances, and may be configured as other values, which is not limited in the disclosure. When a corresponding relation between the information and each parameter is arranged, it is not certainly required to configure all corresponding relations indicated in each table. For instance, in tables in the disclosure, corresponding relations shown in some rows may not be configured. For instance, appropriate deformation adjustments can be made on the basis of the above tables, such as splitting and merging. Other names that can be understood in the communication apparatus may be used as names of parameters shown in titles of the above tables. Other values or expression modes that can be understood in the communication apparatus may be used as values or expression modes of the parameters. When the above tables are implemented, other data structures may be used, such as an array, a queue, a container, a stack, a linear table, a pointer, a linked list, a tree, a graph, a structure, a class, a heap, a hash table, or a hash table.

Predefinition in the disclosure may be understood as definition, predefinition, storage, prestorage, prenegotiation, preconfiguration, solidification, or prefiring.

Those of ordinary skill in the art can appreciate that units and algorithm steps described in combination with examples disclosed here can be implemented by electronic hardware, or a combination of computer software and electronic hardware. Whether these functions are executed by hardware or software depends on the specific application and design constraints of the technical solution. Those skilled in the art can implement the described functions through different methods for each particular application, but such implementation should not be considered as falling beyond the scope of the disclosure.

Those skilled in the art can clearly understand that for convenience and conciseness of description, the specific working process of the systems, apparatuses and units described above can be obtained with reference to the corresponding process in the above method examples, and will not be repeated here.

It should be understood that steps may be rearranged, added or deleted with various flows shown above. For instance, as long as the desired results of the disclosed technical solutions of the disclosure can be achieved, steps described in examples of the disclosure may be executed in parallel, in sequence, or in different sequence, which is not limited here.

The above particular embodiments do not limit the scope of protection of the disclosure. Those skilled in the art should understand that according to design requirements and other factors, various modifications, combinations, subcombinations and substitutions can be made. Any modifications, equivalent substitutions, improvements, etc. made within the spirit and principles of the disclosure shall fall within the scope of protection of the disclosure.

1. A transmitting method for an uplink channel, executed by a terminal device, the transmitting method comprising:
receiving indication information related to precoding transmitted by a network device;
determining a precoding codeword corresponding to each sub-band of the uplink channel according to the indication information;
precoding each sub-band of the uplink channel with the precoding codeword corresponding to each sub-band; and
transmitting the uplink channel, of which each sub-band has been precoded, to the network device.

2. The transmitting method according to claim 1, wherein the indication information is configured to indicate at least one of the following:
at least one transmission precoding matrix indicator (TPMI);
a first wideband precoding matrix indicator (PMI) information;
a number L of beams comprised in a first wideband beam group, wherein L is a positive integer;
a beam forming pattern corresponding to the first wideband beam group;
channel state information (CSI) comprising PMI information of at least one sub-band; and
part of channel state information (CSI).

3. The transmitting method according to claim 2, wherein the indication information is configured to indicate the at least one transmission precoding matrix indicator (TPMI), and determining the precoding codeword corresponding to each sub-band of the uplink channel according to the indication information comprises:
determining a candidate codeword set according to the indication information; and
determining the precoding codeword corresponding to each sub-band of the terminal device from the candidate codeword set.

4. The transmitting method according to claim 3, wherein a number of sub-bands is greater than a number of precoding codewords in the candidate codeword set, and determining the precoding codeword corresponding to each sub-band of the terminal device from the candidate codeword set comprises:
sub-bands of the terminal device being divided into at least two cyclic mapping units, wherein sub-bands in each cyclic mapping unit correspond to, in sequence of the sub-bands in a corresponding cyclic mapping unit, at least one codeword in the candidate codeword set;
or wherein a number of the sub-bands is less than or equal to a number of the precoding codewords in the candidate codeword set, and determining the precoding codeword corresponding to each sub-band of the terminal device from the candidate codeword set comprises:
at least one codeword in the candidate codeword set corresponding to each of the at least one sub-band in sequence.

5. (canceled)

6. The transmitting method according to claim 3, wherein the indication information is configured to indicate the at least one TPMI, and determining the precoding codeword corresponding to each sub-band of the terminal device from the candidate codeword set comprises:
determining a mapping relation between at least one precoding codeword in the candidate codeword set and each sub-band; and
determining the precoding codeword used to precode each sub-band of the uplink channel according to the mapping relation.

7. The transmitting method according to claim 3, wherein the indication information is further configured to indicate at least one of:
a difference between the at least one TPMI and a reference value; and
an index of a set comprising the at least one TPMI.

8. The transmitting method according to claim 2, wherein the indication information is configured to indicate the first wideband precoding matrix indicator (PMI) information, and determining the precoding codeword corresponding to each sub-band of the uplink channel according to the indication information comprises:
determining the first wideband beam group according to the first wideband PMI information, the number L of the beams comprised in the first wideband beam group, and/or the beam forming pattern corresponding to the first wideband beam group;
determining a second sub-band PMI information corresponding to each sub-band according to the first wideband beam group; and
determining the precoding codeword corresponding to each sub-band according to the first wideband PMI information, the first wideband beam group and the second sub-band PMI information corresponding to each sub-band.

9. The transmitting method according to claim 8, wherein the number L of the beams comprised in the first wideband beam group is greater than 1, and determining the second sub-band PMI information corresponding to each sub-band according to the first wideband beam group comprises:
determining, in predefined sequence or in sequence indicated by a signaling, a beam corresponding to each sub-band from a plurality of beams in the first wideband beam group; and
determining the second sub-band PMI information corresponding to each sub-band according to the beam corresponding to each sub-band.

10. The transmitting method according to claim 9, wherein determining, in predefined sequence or in sequence indicated by a signaling, the beam corresponding to each sub-band from the plurality of beams in the first wideband beam group comprises:
determining, according to sequence of any beam in the first wideband beam group and the number L of the beams comprised in the first wideband beam group, a sub-band position corresponding to the beam.

11. The transmitting method according to claim 8, wherein transmission of the uplink channel is transmission of a configured grant physical uplink shared channel (CG PUSCH), and the transmitting method further comprises:
determining a beam forming pattern corresponding to an update period from a beam forming pattern set in predefined sequence or in sequence indicated by a signaling, and taking the beam forming pattern as the beam forming pattern corresponding to the first wideband beam group, wherein the number L of the beams comprised in the first wideband beam group is greater than 1.

12. (canceled)

13. The transmitting method according to claim 2, wherein the indication information is configured to indicate the first wideband PMI information, and the transmitting method further comprises:
transmitting a codebook generation parameter to the network device.

14. A receiving method for an uplink channel, executed by a network device, the receiving method comprising:
transmitting indication information related to precoding to a terminal device, wherein the indication information is configured for the terminal device to determine a precoding codeword corresponding to each sub-band of the uplink channel; and
receiving the uplink channel, of which each sub-band has been precoded, transmitted by the terminal device.

15. The receiving method according to claim 14, wherein the indication information is configured to indicate at least one of the following:
at least one transmission precoding matrix indicator (TPMI);
a first wideband precoding matrix indicator (PMI) information;
a number L of beams comprised in a first wideband beam group, wherein L is a positive integer;
a beam forming pattern corresponding to the first wideband beam group;
channel state information (CSI) comprising PMI information of at least one sub-band; and
part of channel state information (CSI).

16. The receiving method according to claim 15, wherein the indication information is configured to indicate the at least one transmission precoding matrix indicator (TPMI), the at least one transmission precoding matrix indicator (TPMI) is configured to determine a candidate codeword set, and the precoding codeword corresponding to each sub-band of the uplink channel is a precoding codeword in the candidate codeword set.

17. The receiving method according to claim 16, wherein the indication information is further configured to indicate at least one of:
a difference between the at least one TPMI and a reference value; and
an index of a set comprising the at least one TPMI.

18. (canceled)

19. The receiving method according to claim 15, wherein the indication information is configured to indicate the first wideband PMI information, and the receiving method further comprises: receiving a codebook generation parameter transmitted by the terminal device.

20. (canceled)

21. (canceled)

22. A communication apparatus, comprising a processor and a memory, wherein a computer program is stored in the memory, and the processor executes the computer program stored in the memory to cause the communication apparatus to execute a transmitting method for an uplink channel, the transmitting method comprising:
receiving indication information related to precoding transmitted by a network device;
determining a precoding codeword corresponding to each sub-band of the uplink channel according to the indication information;
precoding each sub-band of the uplink channel with the precoding codeword corresponding to each sub-band; and
transmitting the uplink channel, of which each sub-band has been precoded, to the network device.

23. A communication apparatus, comprising a processor and a memory, wherein a computer program is stored in the memory, and the processor executes the computer program stored in the memory to cause the communication apparatus to execute the receiving method according to claim 14.

24. (canceled)

25. (canceled)

26. A non-transitory computer-readable storage medium, configured to store an instruction, wherein the instruction causes the transmitting method according to claim 1 to be implemented when executed.

27. A non-transitory computer-readable storage medium, configured to store an instruction, wherein the instruction causes the receiving method according to claim 14 to be implemented when executed.
